(19) United States
(12) Patent Application Publication
(10) Pub. No.: US 2019/0262230 A1
(43) Pub. Date: Aug. 29, 2019

(54) CONTAINER CAP WITH CONDITIONAL INDICATION AND LOCKING MECHANISM

(71) Applicant: WATERIO LTD, Ness Ziona (IL)

(72) Inventor: Yakov BENTKOVSKI, Givatayim (IL)

(73) Assignee: WATERIO LTD, Ness Ziona (IL)

(21) Appl. No.: 16/342,840

(22) PCT Filed: Oct. 25, 2017
(86) PCT No.: PCT/IB2017/001422

§ 371 Date: Apr. 17, 2019

Related U.S. Application Data
(60) Provisional application No. 62/412,339, filed on Oct. 25, 2016.

(51) Int. Cl. A61J 1/14; A61J 1/18; B65D 41/04; B65D 41/26; B65D 50/00

(52) U.S. Cl. CPC A61J 1/1418; A61J 1/1437; A61J 1/18; B65D 41/0428; B65D 41/26; B65D 2215/00; A61J 2200/30; A61J 2200/72; A61J 2200/74; A61J 2205/60; B65D 50/00

(57) ABSTRACT

An assembly for controlling access to contents of a container includes a cap configured to close the container when mounted thereon; a plurality of sensors configured to sense environmental, physical and/or temporal conditions on the cap; and a processor configured to process data from one or more of the sensors based upon the sensed environmental, physical and/or temporal conditions and configured to provide an indication to a user of recommended access to the container. In certain embodiments, the assembly also includes an electromechanical locking unit configured to selectively lock the cap onto the container and to unlock the cap from the container to allow access to the container, and the processor is configured to unlock the electromechanical locking unit to allow the cap to be detached from the container upon fulfillment of one or more predetermined environmental, physical and/or temporal conditions.

### CROSS-REFERENCE TO RELATED APPLICATIONS

The present application claims the benefit of U.S. Provisional Patent Application No. 62/412,339, filed Oct. 25, 2016, which is herein incorporated by reference in its entirety.

### FIELD OF THE INVENTION

The present invention generally relates to a container cap, and more particularly relates to a container cap with a locking/unlocking mechanism that operates to allow access to contents of the container only upon fulfillment of a specific condition related to the container.

### BACKGROUND OF THE INVENTION

Each medicament or medical drug generally has a prescribed therapeutic range or a certain set of storage or administration conditions within which the effects of taking the drug are beneficial and outside which the effects of taking the drug can be deleterious or, in some cases, hazardous. It is critically important that a patient follow the directions that have been prescribed to the patient for the particular medication and comply with the prescribed therapeutic range or set of storage or administration conditions, as failure to do so can be hazardous to the patient's health. This problem is particularly severe for elderly patients who are generally beset with multiple ailments requiring numerous drugs and directions. The fading memory and confusion that come with age further compound the problem.

Each medicine has recommended guidelines and conditions for storage, transportation or administration of the medicine. For example, some medicines are intended to be administered within a certain amount of time after packaging (i.e., an expiration date) or after the first opening of the package. Similarly, some medicines are intended to be administered only at certain times of a day or at specific intervals. In addition, some medicines are intended to be stored within a particular range of atmospheric or environmental conditions such as temperature and humidity, or there are physical conditions that are required to be satisfied prior to administration. For instance, it may be recommended to shake the medicine container before ingesting or administering the medicine.

Currently, medicines including pills, capsules, tablets, caplets and the like have traditionally been packaged in bottles or other such containers capped with a variety of closure devices. The caps or closures for these containers have taken a variety of forms and, more recently, have included a key system, depress-and-turn system, or the like, designed to prevent small children from gaining access to the contents.

However, when the medicine has passed its expiration date or has been open for too long after its first use, however, the container does not prevent the patient from using the medicines anyway. Moreover, a typical medicine container does not prevent a patient from taking a medicine that is prescribed for administration at different intervals or times of day. In addition, typical medicine containers do not have features to prevent patients from taking medicines whose storage or transportation was not in accordance with the recommended guidelines. Similarly, the container does not prevent the use of the medicine if the patient fails to shake the container as recommended before use.

Therefore, there is a need for a system or device that is able to protect patients from using an inappropriate medicine, such as a medicine having an expired date or that was improperly stored or transported, was insufficiently shaken prior to use, etc., or from using an appropriate medicine at an inappropriate time, by preventing the container in which the medicine is packaged from being opened or unlocked. Further, the system should be able to protect the medicines or other products from unattended use by children. Such a system should also be able to alert the user as to the locked/unlocked status of the container and provide the patent whose attempts to open the container have been denied with a notification as to why the attempts to open the container have been denied.

### SUMMARY OF THE INVENTION

Accordingly, it is an object of the present invention to provide a system or device that protects patients from using an inappropriate medicine, such as a medicine having an expired date or that was improperly stored or transported, or was insufficiently shaken prior to use, etc., or from using an appropriate medicine at an inappropriate time, by preventing the container in which the medicine is packaged from being opened or unlocked.

It is also an object of the present invention to provide the patent with an alert or indication of the locked/unlocked status of the container and to provide the patent whose attempts to open the container have been denied with a notification as to why the attempts to open the container have been denied.

In accordance with the objects of the present invention, the invention comprises an assembly including a container cap that is detachably attached to a container and is controlled by an electromechanical locking mechanism that operates to unlock the container only upon fulfillment of certain specific conditions. In certain embodiments, the assembly is configured just to provide an indication to a user of recommended access to the container.

In accordance with the present invention, the invention comprises an assembly for controlling access to the contents of a container, including a cap configured to close the container when mounted thereon; a plurality of sensors configured to sense environmental, physical and/or temporal conditions on the cap; and a processor configured to process data from one or more of the sensors based upon the sensed environmental, physical and/or temporal conditions and configured to provide an indication to a user of recommended access to the container. In certain embodiments, the assembly also includes an electromechanical locking unit configured to selectively lock the cap onto the container and to unlock the cap from the container to allow access to the container, and the processor is configured to unlock the electromechanical locking unit to allow the cap to be detached from the container upon fulfillment of one or more predetermined environmental, physical and/or temporal conditions.

In certain embodiments, the invention comprises an assembly for controlling access to contents of a container, including a cap configured to close the container when mounted thereon; an electromechanical locking unit configured to selectively lock the cap onto the container and to unlock the cap from the container to allow access to the container; a plurality of sensors configured to sense environmental, physical and/or temporal conditions on the cap; and a processor configured to process data from one or more of the sensors based upon the sensed environmental, physical and/or temporal conditions and configured to unlock the electromechanical locking unit to allow the cap to be detached from the container upon fulfillment of one or more predetermined environmental, physical and/or temporal conditions.

In certain embodiments, the plurality of sensors comprises a temperature sensor, a humidity sensor, a vibration, shock or motion sensor, a clock, an ultraviolet, infrared or visible light sensor, or a chemicals sniffer.

In certain embodiments, the assembly further comprises a memory unit connected to the processor for storing the one or more predetermined environmental, physical and/or temporal conditions related to the contents of the container, wherein the processor determines, based upon the data from the one or more of the sensors, whether the one or more stored predetermined environmental, physical and/or temporal conditions has been fulfilled.

In certain embodiments, the one or more stored predetermined environmental, physical and/or temporal conditions comprise conditions that are specifically related to the contents of the container. In other embodiments, the one or more stored predetermined environmental, physical and/or temporal conditions comprise conditions that are general and not necessarily specifically related to the contents of the container.

In certain embodiments, wherein the plurality of sensors comprises a temperature sensor, the processor is configured to determine, based upon data from the temperature sensor, if a temperature at which the container has been stored is within a predetermined range of acceptable container storage temperatures.

In certain embodiments, wherein the plurality of sensors comprises a humidity sensor, the processor is configured to determine, based upon data from the humidity sensor, if a humidity at which the container has been stored is within a predetermined range of acceptable container storage humidity.

In certain embodiments, wherein the plurality of sensors comprises a clock, the processor is configured to determine, based upon data from the clock, if an expiration date of contents of the container has passed or if an amount of time since a first or previous unlocking of the container exceeds a predetermined amount of time.

In certain embodiments, wherein the plurality of sensors comprises a vibration, shock or motion sensor, the processor is configured to determine, based upon data from the vibration or motion sensor, if the container has been shaken, the vigorousness of the shaking, and if the amount that the container has been shaken and/or the intensity with which the container has been shaken exceeds a predetermined amount.

In certain embodiments, wherein the plurality of sensors further comprises a clock in addition to a vibration, shock or motion sensor, the processor is configured to determine, based upon data from the vibration, shock or motion sensor and data from the clock, if an amount of time since a most recent time that the container has been acceptably shaken exceeds a predetermined amount of time.

In certain embodiments, wherein the plurality of sensors comprises a chemicals sniffer, the processor is configured to determine, based upon data from the chemicals sniffer, if a chemical analyte that has been detected by the chemicals sniffer is present within a predetermined acceptable amount, concentration or range.

In certain embodiments, the assembly further comprises a power source.

In certain embodiments, the assembly further comprises an indicator signal to provide an indication to a user of the locked/unlocked status of the electromechanical locking unit. In certain embodiments, the indicator signal comprises a light to indicate a locked status, wherein the light illuminates upon locking of the electromechanical locking unit. In certain embodiments, the light comprises an LED. In certain embodiments, the light has a first color to indicate a locked status and has a second color to indicate an unlocked status, wherein the light illuminates in the first color upon locking of the electromechanical locking unit and illuminates in the second color upon unlocking of the electromechanical locking unit.

In certain other embodiments, the light comprises a first light to indicate a locked status and a second light to indicate an unlocked status, wherein the first light illuminates upon locking of the electromechanical locking unit and the second light illuminates upon unlocking of the electromechanical locking unit. In certain embodiments, the first light and the second light illuminate in different colors.

In certain embodiments, the indicator signal comprises a graphic representation, such as an icon or a symbol, that conveys an understanding of the locked/unlocked status of the electromechanical locking unit.

In certain embodiments, the cap comprises an internal cap detachably mounted on the container, and the assembly further comprises an external cap covering the electromechanical locking unit, the plurality of sensors, the processor and the internal cap. In this embodiment, when the electromechanical locking unit is unlocked to allow the internal cap to be detached from the container, the external cap can be turned so as to detach the internal cap from the container and thereby gain access to the container.

In certain embodiments, the electromechanical locking unit is able to operate either remotely or locally upon fulfillment of a specific condition. Furthermore, the system should be able to receive payments via smartphone for pay per use. The system should be able to notify the user by LED, i.e., when the product is available for use and when it is unavailable for use. Furthermore, the container cap may have a wireless communication to receive wireless commands from a wireless computing device.

### BRIEF DESCRIPTION OF THE DRAWINGS

The foregoing and other objects, features, and advantages of the present invention, as well as the invention itself, is more fully understood from the following description of various embodiments, when read together with the accompanying drawings.

FIGS. 1A and 1B show exemplary embodiments of a container cap assembly in accordance with embodiments of the present invention;

FIG. 2 illustrates a schematic sectional view of the container cap assembly in accordance with an embodiment of the present invention;

FIG. 3 illustrates a block diagram of electronics parts of the container cap assembly, in accordance with an embodiment of the present invention;

FIG. 4 illustrates a cutaway view of a container cap assembly, in accordance with an embodiment of the present invention;

FIG. 5 illustrates a cutaway view of a container cap assembly and an electromechanical locking unit, in accordance with an embodiment of the present invention;

FIG. 6 illustrates a perspective view of a container cap assembly and an electromechanical locking unit, in accordance with an embodiment of the present invention; and

FIG. 7 illustrates a plan view of an electromechanical locking unit, in accordance with an embodiment of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it is apparent to one skilled in the art that the present invention may be practiced without the specific details presented herein. Furthermore, well known features may be omitted or simplified in order not to obscure the present invention.

There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

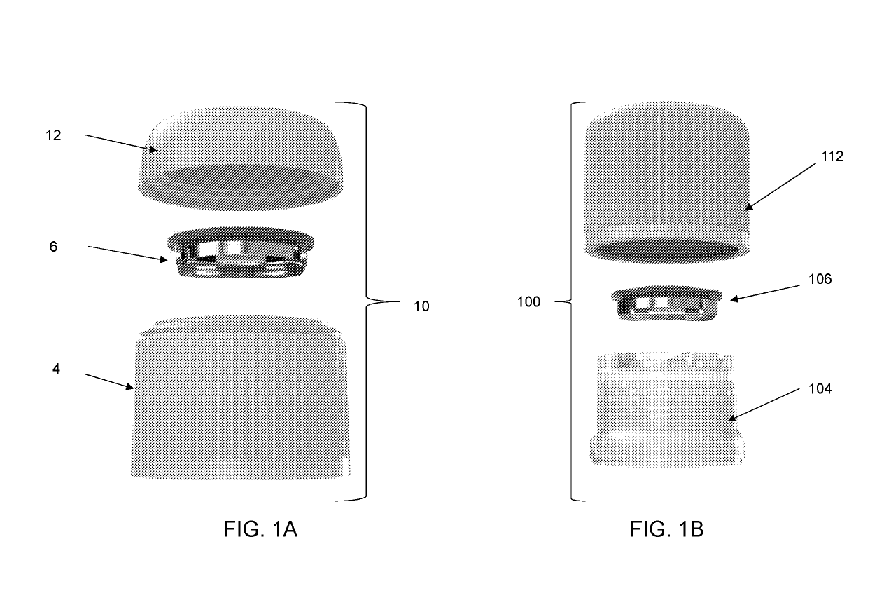

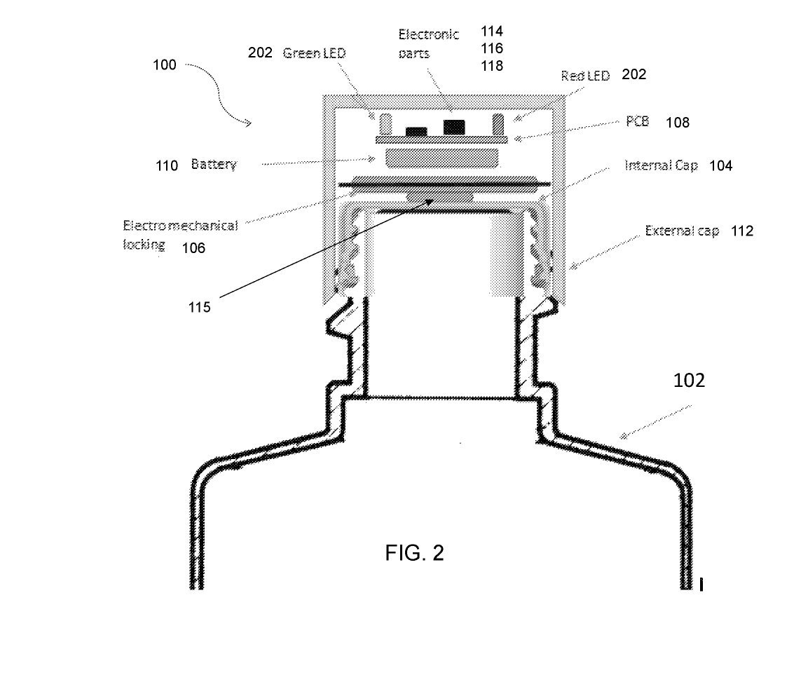

FIGS. 1A and 1B show container cap assemblies in which a container cap may be detachably attached to a container to control access to the contents of the container and in which the container cap is controlled by an electromechanical locking mechanism that operates to unlock the container and allow access to the container only upon fulfillment of certain specific conditions that are related to the contents of the container. The container cap assemblies of FIGS. 1A and 1B are slightly different, as will be described below.

In one embodiment, as shown in FIG. 1A, a container cap assembly 10 is detachably attached to a container (not shown) to provide a closure thereto. The container cap assembly 10 includes a lower cap 4 that is to be detachably mounted onto the container to allow or prevent access to the container, depending upon whether the lower cap is unlocked or locked, respectively. An electromechanical locking unit 6 is attached, either mechanically, electronically or both, to lower cap 4 so as to control the locked/unlocked status of lower cap 4. The electromechanical locking unit 6 is positioned on the upper surface of the top of the lower cap 4 that protects access to the contents of the container, and an upper cap 12 covers the lower cap 4 and the electromechanical locking unit 6 above it.

In another embodiment, as shown in FIG. 1B, a container cap assembly 100 is detachably attached to a container (not shown) to provide a closure thereto. The container cap assembly 100 includes an internal cap 104 that is to be detachably mounted onto the container to allow or prevent access to the container, depending upon whether the lower cap is unlocked or locked, respectively. An electromechanical locking unit 106 is attached, either mechanically, electronically or both, to internal cap 104 so as to control the locked/unlocked status of internal cap 104. The electromechanical locking unit 106 is positioned on the upper surface of the top of internal cap 104 that protects access to the contents of the container, and an external cap 112 covers internal cap 104 and the electromechanical locking unit 106 above it.

As described herein, the word “cap” refers to any closure device that is used to close, seal or restrict access to the container through its mouth, including but not limited to a threaded engagement, a friction fit, a snap fit, an expandable insertion, such as a cork. In many of the embodiments described herein, the cap is typically able to be locked by a suitable locking mechanism.

In the two embodiments shown in FIGS. 1A and 1B, the electromechanical locking unit 6,106 is positioned between two caps layers, i.e., an upper cap 12 that covers the lower cap 4 and the electromechanical locking unit 6 between them in FIG. 1A, and an external cap 112 that covers the internal cap 104 and the electromechanical locking unit 106 between them in FIG. 1B.

It should be note that other embodiments of the container cap assembly may be provided wherein a cap is detachably mounted onto the container to allow or prevent access to the container, and an electromechanical locking unit is attached, either mechanically, electronically or both, to cap so as to control the locked/unlocked status of the cap to thereby allow or prevent access to the container.

FIG. 2 illustrates a schematic cross-sectional view of an exemplary embodiment of a container cap with a conditional locking mechanism. It should be noted that the embodiment shown in FIG. 2 is illustrated using the version of the container cap assembly shown in FIG. 1B, including the arrangement of elements shown therein. However, the embodiment shown in FIG. 2 could just as easily be illustrated using the version of the container cap assembly shown in FIG. 1A, including the arrangement of elements shown therein. Accordingly, it should be realized that the description of the elements of the version of the container cap assembly shown in FIG. 1B applies similarly to the version of the container cap assembly shown in FIG. 1A.

As shown in the exemplary embodiment of FIG. 2, a container cap assembly 100 is configured to be detachably attached to a container 102 to provide a closure thereto in accordance with a preferred embodiment of the present invention. The container cap assembly 100 includes an internal cap 104 that is detachably mounted onto container 102 to allow or prevent access to the container, depending upon whether the internal cap is unlocked or locked, respectively. The internal cap 104 is detachably mounted on the container 102 at the mouth thereof.

An electromechanical locking unit 106 is attached, either mechanically, electronically or both, to internal cap 104 so as to control the locked/unlocked status of internal cap 104. A plurality of sensors 114 and a processor or controller 118 are coupled to electromechanical locking unit 106. The container cap assembly 100 may also include a power source 110, such as a battery, a memory unit 116, and a clock 117. The container cap assembly 100 may further include a printed circuit board 108 to allow all these elements to be electrically connected to one another as is generally known in the art.

In certain embodiments, the container cap assembly 100 further comprises a memory unit 116 for storing the one or more predetermined environmental, physical and/or temporal conditions, which may be general or specifically related to the contents of the container. The memory unit 116 may be connected to the processor or controller 118. In certain embodiments, the memory unit 116 may be mounted on the printed circuit board 108, which may be electronically connected to the processor or controller 118. The one or more predetermined environmental, physical and/or temporal conditions may be conditions, either general or specifically related to related to the contents of the container, under which the electromechanical locking unit 106 may be locked and unlocked.

In some embodiments, container cap assembly 100 comprises one or more indicator signals to provide an indication to a user of the locked/unlocked status of the electromechanical locking unit. The indicator signal could include one or more light source units, such as LEDs 202, such as one light source unit to indicate a locked status (e.g., red LED) and a different light source unit to indicate an unlocked status (e.g., green LED). As discussed below, the one or more indicator signals could include an icon or a symbol on external cap 112 in association with each of the light source units 202 to graphically indicate the locked/unlocked status of the internal cap associated with LED 202.

In some embodiments, container cap assembly 100 includes a wireless transmitter to transmit data to a remote location and/or a wireless receiver to accept transmission of data from a remote location, such as a wireless computing device.

As shown in FIG. 2, the container cap assembly 100 further comprises an external cap 112 covering the electromechanical locking unit 106, the other items associated with it, and the internal cap 104. In this embodiment, when the electromechanical locking unit 106 is unlocked to allow the internal cap 104 to be detached from the container 102, the external cap 112 can be grasped by the user so as to turn the entire container cap assembly 100, which detaches the internal cap 104 from the container 102, to thereby gain access to the container 102.

Sensors 114 may be configured to monitor one or more environmental, physical and/or temporal conditions on the internal cap 104 or on the external cap 112, collect data therefrom, and provide the data to the processor or controller 118. The sensors 114 may be electronically connected to the processor or controller 118. In certain embodiments, sensors 114 may be mounted on the printed circuit board 108, which may be electronically connected to the processor or controller 118.

Examples of the plurality of sensors 114 include, but are not limited to, a temperature sensor, a humidity sensor, a vibration, shock or motion sensor, a clock, an ultraviolet, infrared or visible light sensor, or a chemicals sniffer.

In certain embodiments, the container cap assembly 100 further comprises one or more sensors 115 that may be configured to monitor one or more environmental, physical and/or temporal conditions underneath the internal cap 104, i.e., inside the container 102, collect data therefrom, and provide the data to the processor or controller 118. The sensors 115 may include those enumerated hereinabove and may be electronically connected to the processor or controller 118. In certain embodiments, sensors 115 may be mounted on the internal cap 104, so as to be able to sense inside container 102, either through a window or an aperture.

Clock 117, which may be considered one of sensors 114, may be electronically connected to the processor or controller 118. In certain embodiments, clock 117 may monitor the passage of time and may keep a record of times when the container has been opened.

The electromechanical locking unit 106 is detachably attached to, or may simply be covered by, the external cap 112 and may be coupled to the internal cap 104. The electromechanical locking unit 106 may also be electronically connected to the processor or controller 118. In certain embodiments, electromechanical locking unit 106 may be connected to the printed circuit board 108, which may be electronically connected to the processor or controller 118. Upon activation by processor or controller 118, the electromechanical locking unit 106 is unlocked to allow the internal cap 104 to be detached from container 102, so as to thereby allow access to the contents of container 102.

The electromechanical locking unit 106 may be implemented using electromagnetic, solenoid, piezoelectric, mechanical attachment or any other similar electronic signals driving mechanical movement, etc., by any suitable mechanism as may be well known in the art.

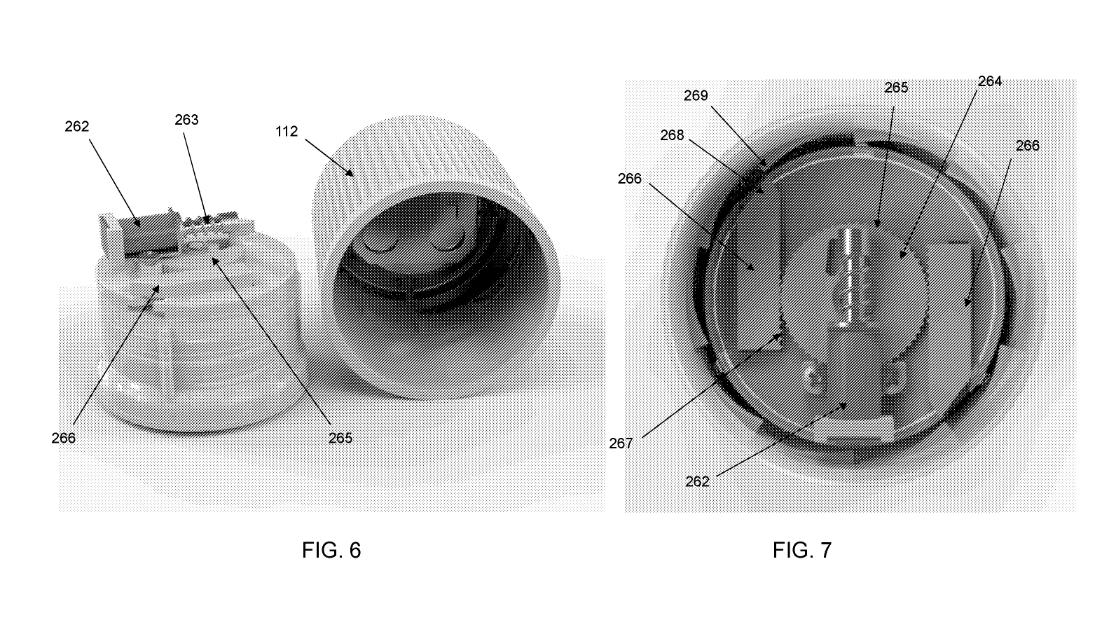

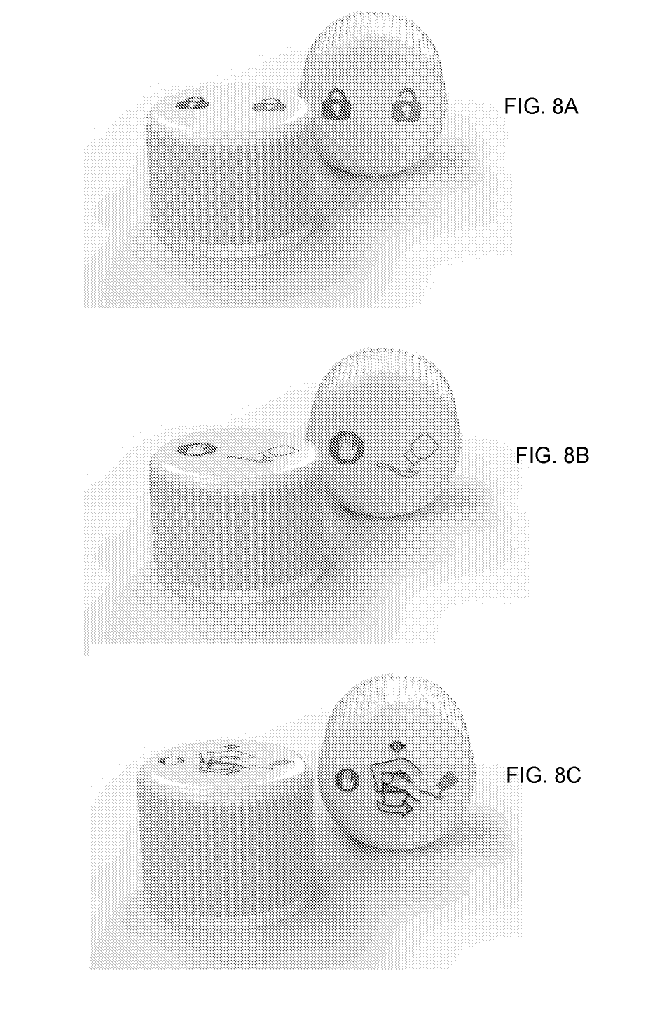

In one exemplary embodiment, as shown in FIGS. 5-7, electromechanical locking unit 106 may comprise an electromagnet 260 comprising a linear solenoid actuator 262 with a return spring 263. The actuator 262 is mechanically connected to a central pinion 264 having a pitch circle whose teeth 265 engage with at least one rack 266. FIG. 7 shows that the electromechanical locking unit 106 may comprise two linear racks 266 having pitch lines 267 that are engaged by the teeth 265 of the central pinion 264. The ends 268 of the rack 266 may engage with locking pins 269 in the circumference of the internal cap 104 to prevent its rotation about the opening of container 102 or may disengage from the locking pins to permit rotation of internal cap 104. In the exemplary embodiment of FIGS. 5-7, when the electromechanical locking unit 106 is activated, i.e., locked, linear solenoid actuator and return spring turn central pinion clockwise such that the gears of pitch circle push the linear racks towards the edges of internal cap 104, such that the ends of the racks engage with the locking pins in the circumference of the internal cap 104 to prevent its rotation. When the electromechanical locking unit 106 is deactivated, i.e., unlocked, linear solenoid actuator and return spring turn central pinion counterclockwise such that the gears of pitch circle pull the linear racks into the center of internal cap 104 and away from the edges of internal cap 104, such that the ends of the racks disengage from the locking pins in the circumference of the internal cap 104 to allow its rotation.

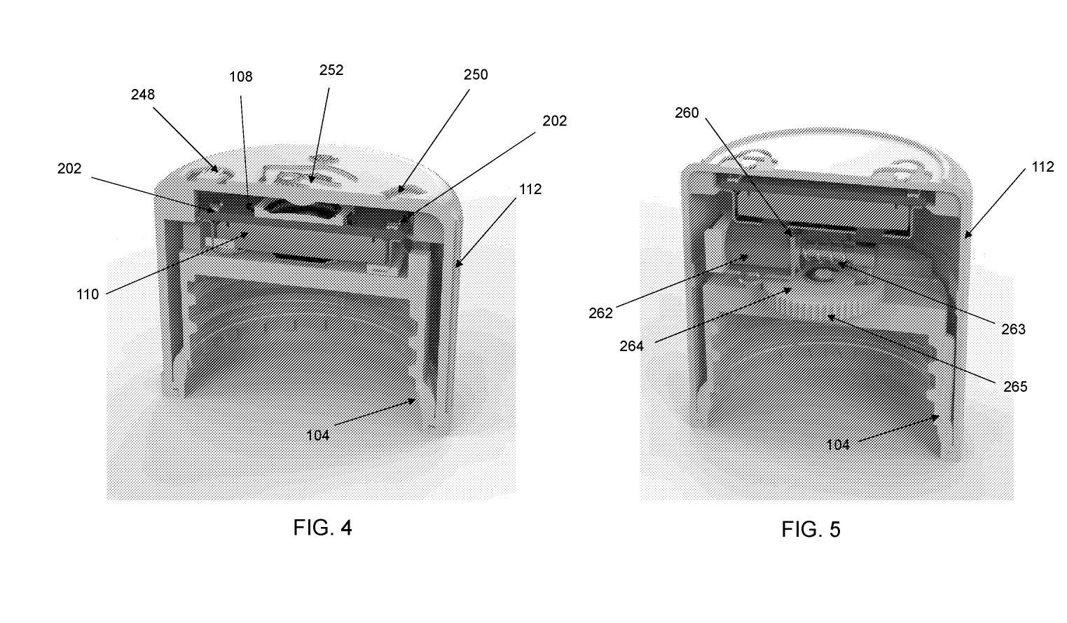

As shown in FIGS. 4 and 5, light source units 202, which may be LEDs or any other suitable light source, may be mounted electronically in the container cap assembly 100 to the printed circuit board 108, which may be electronically connected to the processor or controller 118. The light source units 202 may include a green LED and a red LED to indicate the unlocked status and the locked status, respectively, of the electromechanical locking unit 106. The illumination of light source units 202 may respond to the conditions stored in the memory unit 206 under the direction of processor or controller 118, namely to indicate whether or not the electromechanical locking unity 106 has been unlocked in response to analysis by the processor or controller 118 as to whether one or more of the environmental, physical and/or temporal conditions has been fulfilled.

The container cap assembly 100 may also include an icon or a symbol 248, 250 on external cap 112 in association with each of the light source units 202 to graphically indicate the locked/unlocked status of the internal cap associated with LED 202.

For example, as shown in FIGS. 5 and 8A, symbol 248 may show a locked icon in the form of a closed lock, which may be illuminated in a red color by the appropriate one of light source units 202 when electromechanical locking unit 106 is locked and the medicine container is not available to be accessed, and symbol 250 may show an unlocked icon in the form of an open lock, which may be illuminated in a green color by the appropriate one of light source units 202 when electromechanical locking unity 106 is unlocked and the medicine container is available to be accessed. Alternatively, as shown in FIGS. 4 and 8B, symbols 248 and 250 may be different locked and unlocked icons, respectively, which may be illuminated in red and green colors, respectively, by the appropriate ones of light source units 202 when electromechanical locking unity 106 is locked and unlocked, respectively.

In addition, the external cap 112 may include an additional child safety provision, as known in the art, such as that the cap must be pressed down when being turned in order to be opened. As shown in FIGS. 4 and 8B, the external cap 112 may contain an additional icon to indicate that such a provision is present.

The power source 110 powers the printed circuit board or processor 108 as well as other components in the container cap assembly 100. Examples of the power source 110 include but are not limited to a battery.

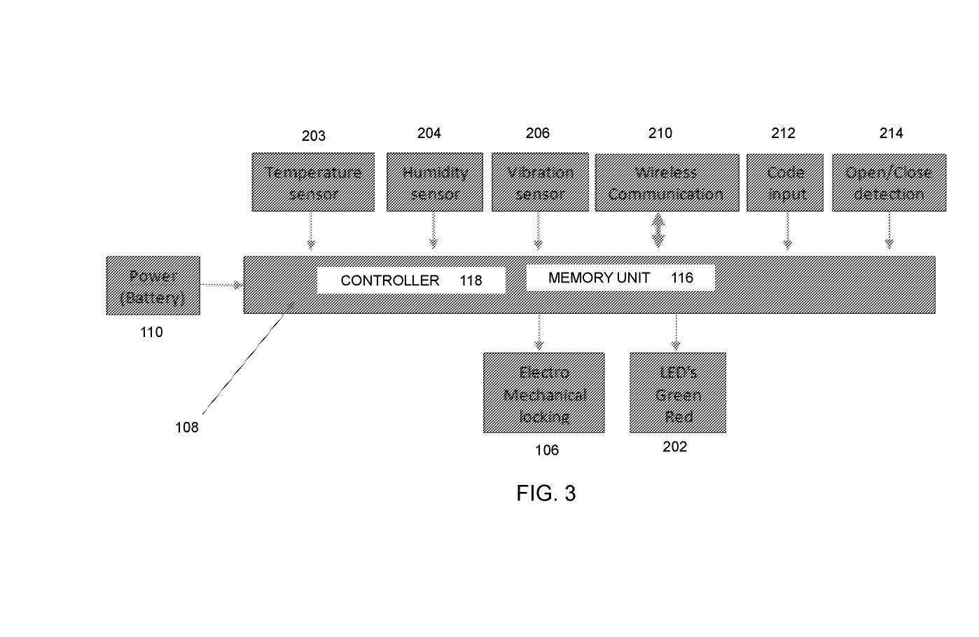

The plurality of sensors 114, the memory unit 116, and the processor/controller 118, which are collectively shown as electronic parts in FIG. 2, are also explained in conjunction with FIG. 3. FIG. 3 illustrates a block diagram of electronic parts 200 attached to the electromechanical locking unit 106 and light source unit 202 in accordance with a preferred embodiment of the present invention. The plurality of sensors 114, such as temperature sensor 203, humidity sensor 204 and vibration sensor 206, among others discussed herein, which are configured to check a variety of environmental, physical and/or biological conditions, are connected to the printed circuit board 108, which is connected to the processor/controller 118 and memory device 116. All components in the container cap assembly 100 may be powered by power source 110.

The processor/controller 118 processes signals and data from the sensors 114 and determines, based upon the data from the one or more of the sensors and data stored in memory, whether the one or more stored predetermined environmental, physical and/or temporal conditions has been fulfilled, the electromechanical locking unit 106 may be unlocked. Thus, the processor or controller 118 unlocks and locks the electromechanical locking unit 106 based upon fulfillment of certain conditions. In addition, light source units 202 may be illuminated, and icon or a symbol 248, 250 may be highlighted or illuminated.

Examples of the conditions include but not limited to the following as described below.

In certain embodiments, the container cap assembly 100 may include sensors 114 configured to measure data related to certain storage conditions. For instance, a temperature sensor may measure temperature on the container cap assembly 100, and a humidity sensor may measure the humidity on the container cap assembly 100 (other environmental sensors are possible as well, such as a shock sensor or a UV, Infrared or visible light sensor). The data from the temperature and/or humidity sensors is compared to the data stored in memory relating to the predetermined range of acceptable container storage conditions, including temperature and humidity. Similarly, the data from the UV, Infrared or visible light sensor may be compared to the data stored in memory relating to the predetermined range of acceptable light and radiation exposure levels.

The processor 118 is configured to determine if a temperature or humidity at which the container has been stored is within a predetermined range of acceptable container storage temperatures and humidity, or if the exposure to light and radiation is within an acceptable predetermined range. If so, the electromechanical locking unit 106 may be unlocked, and an indication, e.g., light source units 202 and symbol 250, may be illuminated. If not, the electromechanical locking unit 106 will not be unlocked, and an indication, e.g., light source units 202 and symbol 248, may be illuminated. Thus, the container cap assembly 100 can protect the user from taking medication that may have been spoiled due to exposure to or storage in environmental conditions that do not comply with the manufacturer's instructions (temperature, humidity, shock etc.).

In certain embodiments, a “chemicals sniffer”, which may be used to detect the presence of low airborne concentrations of certain chemicals, such as ammonia, chlorine gas and methane or other chemical analytes, may be used as a sensor. Portable (hand-held and stand-off) chemical detection systems are well-known and are commercially available, and it is possible to miniaturize such a device so that it can be configured as a sensor capable of being incorporated into the container cap assembly 100. Such a chemicals sniffer would be useful in detecting certain chemicals that are released from a medicine when the medicine has expired, has been stored at other than the optimal conditions, has spoiled, or has otherwise ceased to be effective.

In such an embodiment, a chemicals sniffer sensor can be adapted to have specific sensitivity to the medicine contained within the container 102 and to the chemical analytes released thereby. The data from the chemicals sniffer sensor is compared to data stored in memory relating to the predetermined acceptable released chemical analytes for the specific medicine. The processor 118 is configured to determine if a released chemical analyte is within a predetermined acceptable amount, concentration or range. If so, the electromechanical locking unit 106 may be unlocked, and an indication, e.g., light source units 202 and symbol 250, may be illuminated. If not, the electromechanical locking unit 106 will not be unlocked, and an indication, e.g., light source units 202 and symbol 248, may be illuminated. Thus, the container cap assembly 100 can protect the user from taking medication that may have has otherwise ceased to be effective, as detectable by a released chemical analyte.

In certain embodiments, the container cap assembly 100 may include a clock 117 configured to determine the current date and time or to determine the passage of time between two events. The data from the clock 117 is compared to the data stored in memory relating to the predetermined acceptable time conditions. For example, the processor 118 is configured to determine, based upon data from the clock 117, if an expiration date of medication contained within the container 102 has passed, or if an amount of time since a first or previous unlocking of the container exceeds a predetermined amount of time. If so, the electromechanical locking unit 106 will not be unlocked, and an indication, e.g., light source units 202 and symbol 248, may be illuminated, thus protecting the user from taking medication that may be expired or that may have been spoiled.

In certain embodiments, the container cap assembly 100 may include a vibration, shock or motion sensor, such as a gyroscope, accelerometer or other motion sensor, configured to determine the amount of time and vigorousness with which the container 102 was shaken and, in conjunction with the clock 117, the elapsed time since the last agitation. The data from the vibration, shock or motion sensor is compared to the data stored in memory relating to the predetermined minimum agitation that is acceptable according to manufacturer specifications, and the processor is configured to determine, based upon the data from the vibration, shock or motion sensor, if the container has been shaken sufficiently (degree and duration of agitation) and if such agitation has occurred within a recent enough time period. If so, the electromechanical locking unit 106 may be unlocked, and an indication, e.g., light source units 202 and symbol 250, may be illuminated. If not, the electromechanical locking unit 106 will not be unlocked, and an indication, e.g., light source units 202 and symbol 248, may be illuminated. Thus, the container cap assembly 100 can protect the user from taking medication that is ineffective on account of it not having been mixed sufficiently in accordance with the manufacturer's instructions (temperature, humidity, shock etc.).

In certain embodiments, the sensors are configured to measure data continuously, periodically or at regular intervals. In certain embodiments, the sensors are configured to measure data only when the user desires to open the container to access the medicine therein.

In certain embodiments, the processor 118 is configured make its determination whether the environmental, physical and/or temporal conditions have been fulfilled, based upon the data from the sensors 114, continuously, periodically or at regular intervals. In certain embodiments, the processor 118 is configured to make its determination only when the user desires to open the container to access the medicine therein. In certain embodiments, the electromechanical locking unit 106 will not be unlocked until after the processor 118 makes its determination. Similarly, the indicator signals, such as light source units 202 or icon/symbol 248, 250, may be highlighted or illuminated only once the processor 118 makes its determination.

In alternative embodiments, the illumination of light source units 202 may be the only response to the fulfillment of conditions stored in the memory unit 206 under the direction of processor or controller 118. Specifically, in response to analysis by the processor or controller 118 as to whether one or more of the environmental, physical and/or temporal conditions has been fulfilled, the light source units 202 may indicate, such as by illumination of a green LED or red LED, whether it is safe/appropriate or unsafe/inappropriate, respectively, for the user to access the medicine within container 102, thus providing an indication to a user of recommended access to the container. In addition, a graphic representation, such as an icon or a symbol 248, 250 on external cap 112 of the container cap assembly 100 may be illuminated in association with each of the light source units 202 to graphically indicate the safe/appropriate or unsafe/inappropriate status of the medicine within the container 102. However, in one embodiment, the electromechanical locking unit 106 is not locked or unlocked in response to analysis by the processor or controller 118; instead, the assembly provides a warning, alert or indication to the user but does not physically prevent the user from accessing the contents of the container 102. In another embodiment, the electromechanical locking unit 106 can be locked or unlocked in response to analysis by the processor or controller 118, but only after the assembly provides a warning, alert or indication to the user without but physically preventing the user from accessing the contents of the container 102.

In certain embodiments, as shown in FIG. 3, the container cap assembly 100 may include a wireless transmitter and/or a wireless receiver to transmit data to, and accept transmission of data from, a remote location, respectively, such as a wireless computing device. In another embodiment, as shown in FIG. 3, the controller 118 receives command from a code input 212 and the wireless commands 210 to unlock and/or lock the electromechanical locking unit 106.

According to some embodiments of the invention, a computer program application is provided, typically running on a remote computing device, such as a smartphone, tablet computer, laptop, etc., which may provide a user interface for an operator of the container cap assembly 100 to allow user interaction with the container cap assembly 100. The application may employ the computing device's features and capabilities, for computation, input and output, such as, its processor, graphical processor, memory, input/output device and/or interface (e.g., camera, touch-screen, keyboard, etc.), sensors (e.g., gyroscope, accelerometer, microphone, etc.), etc. According to some embodiments, the computing device may communicate with controller 118 over a wireless communication channel, such as a short-range communication technology (e.g., Bluetooth™).

In certain embodiments, the controller 118 is configured to unlock and/or lock the electromechanical locking unit 106 upon receipt of a command from an external device, such as a code input 212 wireless transmitted from a remote device. A specific wireless command may be sent from a remote device (e.g., smartphone, hub) to a wireless receiver in the container cap assembly 100, after which the controller 118 will unlock the electromechanical locking unit 106. Such a command may be issued, for example, once the user has approved a Blockchain agreement approval, authenticated the medicine product within the container 102, or has read and approved certain terms of use of the medicine product stored in the container. Such conditions are not dependent upon data or information sensed by the sensors 114 but rather by data or information provided to a remote device.

Many changes, modifications, variations and other uses and applications of the subject invention will, however, become apparent to those skilled in the art after considering this specification and the accompanying drawings, which discloses the preferred embodiments thereof. All such changes, modifications, variations and other uses and applications which do not depart from the spirit and scope of the invention are deemed to be covered by the invention, which is to be limited only by the claims which follow.?

One skilled in the art will appreciate that the present invention can be practiced by other than the described embodiments, which are presented for purposes of illustration and not limitation. In addition, different embodiments are disclosed herein, and features of certain embodiments may be combined with features of other embodiments, such that certain embodiments maybe combinations of features of multiple embodiments. Further, since numerous modifications and changes will readily occur to those skilled in the art, it is not desired to limit the invention to the exact construction and operation shown and described, and accordingly, all suitable modifications and equivalents may be resorted to, without departing from the scope or spirit of the invention as defined in the appended claims.

1. An assembly for controlling access to contents of a container, the assembly comprising:
a cap configured to close the container when mounted thereon;
an electromechanical locking unit configured to selectively lock the cap onto the container and to unlock the cap from the container to allow access to the container;
one or more sensors configured to sense environmental, physical and/or temporal conditions on or around the cap; and
a processor configured to process data from one or more of the sensors based upon the sensed environmental, physical and/or temporal conditions and configured to unlock the electromechanical locking unit to allow the cap to be detached from the container upon fulfillment of one or more predetermined environmental, physical and/or temporal conditions.

2. The assembly according to claim 1, wherein the one or more sensors comprise a temperature sensor, a humidity sensor, a vibration, shock or motion sensor, a clock, an ultraviolet, infrared or visible light sensor, or a chemicals sniffer.

3. The assembly of claim 1, further comprising a memory unit connected to the processor for storing the one or more predetermined environmental, physical and/or temporal conditions, wherein the processor determines, based upon the data from the one or more of the sensors, whether the one or more stored predetermined environmental, physical and/or temporal conditions has been fulfilled.

4. The assembly according to claim 3, wherein the one or more stored predetermined environmental, physical and/or temporal conditions comprise conditions that are specifically related to the contents of the container

5. The assembly according to claim 3,
wherein the one or more sensors comprise a temperature sensor, and
wherein the processor is configured to determine, based upon data from the temperature sensor, if a temperature at which the container has been stored is within a predetermined range of acceptable container storage temperatures.

6. The assembly according to claim 3,
wherein the one or more sensors comprise a humidity sensor, and
wherein the processor is configured to determine, based upon data from the humidity sensor, if a humidity at which the container has been stored is within a predetermined range of acceptable container storage humidity.

7. The assembly according to claim 3,
wherein the one or more sensors comprise an ultraviolet, infrared or visible light sensor, and
wherein the processor is configured to determine, based upon data from the ultraviolet, infrared or visible light sensor, if an amount of light and radiation to which the container has been exposed is within a predetermined range of acceptable light and radiation exposure levels.

8. The assembly according to claim 3,
wherein the plurality of sensors comprises a clock, and
wherein the processor is configured to determine, based upon data from the clock, if an expiration date of contents of the container has passed or if an amount of time since a first or previous unlocking of the container exceeds a predetermined amount of time.

9. The assembly according to claim 3,
wherein the plurality of sensors comprises a vibration, shock or motion sensor, and
wherein the processor is configured to determine, based upon data from the vibration, shock or motion sensor, if the container has been shaken and if the amount that the container has been shaken or the intensity with which the container has been shaken exceeds a predetermined amount.

10. The assembly according to claim 9,
wherein the plurality of sensors further comprises a clock, and
wherein the processor is configured to determine, based upon data from the vibration, shock or motion sensor and data from the clock, if an amount of time since a most recent time that the container has been acceptably shaken exceeds a predetermined amount of time.

11. The assembly according to claim 3,
wherein the plurality of sensors comprises a chemicals sniffer, and
wherein the processor is configured to determine, based upon data from the chemicals sniffer, if a chemical analyte that has been detected by the chemicals sniffer is present within a predetermined acceptable amount, concentration or range.

12. The assembly according to claim 1, further comprising a power source.

13. The assembly according to claim 1, further comprising an indicator signal to provide an indication to a user of the locked/unlocked status of the electromechanical locking unit.

14. The assembly according to claim 13, wherein the indicator signal comprises a light to indicate a locked status, wherein the light illuminates upon locking of the electromechanical locking unit.

15. The assembly according to claim 14, wherein the light comprises an LED.

16. The assembly according to claim 13, wherein the light has a first color to indicate a locked status and has a second color to indicate an unlocked status, wherein the light illuminates in the first color upon locking of the electromechanical locking unit and illuminates in the second color upon unlocking of the electromechanical locking unit.

17. The assembly according to claim 13, wherein the light comprises a first light to indicate a locked status and a second light to indicate an unlocked status, wherein the first light illuminates upon locking of the electromechanical locking unit and the second light illuminates upon unlocking of the electromechanical locking unit.

18. The assembly according to claim 17, wherein the first light and the second light illuminate in different colors.

19. The assembly according to claim 13, wherein the indicator signal comprises a graphic representation that conveys an understanding of the locked/unlocked status of the electromechanical locking unit.

20. The assembly according to claim 1,
wherein the cap comprises an internal cap detachably mounted on the container, the assembly further comprising an external cap covering the electromechanical locking unit, the plurality of sensors, the processor and the internal cap, and
wherein, when the electromechanical locking unit is unlocked to allow the internal cap to be detached from the container, the external cap can be turned so as to detach the internal cap from the container and thereby gain access to the container.

21. The assembly according to claim 1, further comprising one or more second sensors configured to monitor one or more environmental, physical and/or temporal conditions inside the container.

22. The assembly according to claim 20, wherein said one or more second sensors are situated so as to be able to sense inside the container through a window or an aperture in the cap.

23. An assembly for indicating access to contents of a container, the assembly comprising:
a cap configured to close the container when mounted thereon;
a signal configured to provide an indication to a user of recommended access to the container;
a plurality of sensors configured to sense environmental, physical and/or temporal conditions on the cap; and
a processor configured to process data from one or more of the sensors based upon the sensed environmental, physical and/or temporal conditions and configured to provide an indication to a user of recommended access to the container upon fulfillment of one or more predetermined environmental, physical and/or temporal conditions.

24. The assembly according to claim 23, wherein the indication comprises a light to indicate a recommended access to the container, wherein the light illuminates upon fulfillment of one or more predetermined environmental, physical and/or temporal conditions.

25. The assembly according to claim 23, wherein the indication comprises a light to indicate a non-recommended access to the container, wherein the light illuminates until fulfillment of one or more predetermined environmental, physical and/or temporal conditions.

26. The assembly according to claim 23, wherein the indication comprises a first light to provide an indication to a user of non-recommended access to the container and a second light to provide an indication to a user of recommended access to the container.

27. The assembly according to claim 26, wherein the first light and the second light illuminate in different colors.

28. The assembly according to claim 26, wherein the first and second lights comprise LEDs.

29. The assembly according to claim 23, wherein the indication comprises a light having a first color to indicate a non-recommended access status and having a second color to indicate a recommended access status, wherein the light illuminates in the first color until fulfillment of one or more predetermined environmental, physical and/or temporal conditions and illuminates in the second color upon fulfillment of one or more predetermined environmental, physical and/or temporal conditions.

30. The assembly according to claim 23, wherein the indication comprises a graphic representation to selectively provide an indication to a user of non-recommended access to the container or to provide an indication to a user of recommended access to the container.

31. The assembly according to claim 23, wherein the indication comprises a first graphic representation to provide an indication to a user of non-recommended access to the container and a second graphic representation to provide an indication to a user of recommended access to the container.

32. The assembly according to claim 23, wherein the plurality of sensors comprises a temperature sensor, a humidity sensor, a vibration, shock or motion sensor, a clock, an ultraviolet, infrared or visible light sensor, or a chemicals sniffer.

33. The assembly according to claim 23, further comprising a memory unit connected to the processor for storing the one or more predetermined environmental, physical and/or temporal conditions, wherein the processor determines, based upon the data from the one or more of the sensors, whether the one or more stored predetermined environmental, physical and/or temporal conditions has been fulfilled.

34. The assembly according to claim 33, wherein the one or more stored predetermined environmental, physical and/or temporal conditions comprise conditions that are specifically related to the contents of the container

35. The assembly according to claim 23,
wherein the plurality of sensors comprises a temperature sensor, and
wherein the processor is configured to determine, based upon data from the temperature sensor, if a temperature at which the container has been stored is within a predetermined range of acceptable container storage temperatures.

36. The assembly according to claim 23,
wherein the plurality of sensors comprises a humidity sensor, and
wherein the processor is configured to determine, based upon data from the humidity sensor, if a humidity at which the container has been stored is within a predetermined range of acceptable container storage humidity.

37. The assembly according to claim 23,
wherein the plurality of sensors comprises an ultraviolet, infrared or visible light sensor, and
wherein the processor is configured to determine, based upon data from the ultraviolet, infrared or visible light sensor, if an amount of light and radiation to which the container has been exposed is within a predetermined range of acceptable light and radiation exposure levels.

38. The assembly according to claim 23,
wherein the plurality of sensors comprises a clock, and
wherein the processor is configured to determine, based upon data from the clock, if an expiration date of contents of the container has passed or if an amount of time since a first or previous unlocking of the container exceeds a predetermined amount of time.

39. The assembly according to claim 23,
wherein the plurality of sensors comprises a vibration, shock or motion sensor, and
wherein the processor is configured to determine, based upon data from the vibration, shock or motion sensor, if the container has been shaken and if the amount that the container has been shaken or the intensity with which the container has been shaken exceeds a predetermined amount.

40. The assembly according to claim 39,
wherein the plurality of sensors further comprises a clock, and
wherein the processor is configured to determine, based upon data from the vibration, shock or motion sensor and data from the clock, if an amount of time since a most recent time that the container has been acceptably shaken exceeds a predetermined amount of time.

41. The assembly according to claim 23,
wherein the plurality of sensors comprises a chemicals sniffer, and
wherein the processor is configured to determine, based upon data from the chemicals sniffer, if a chemical analyte that has been detected by the chemicals sniffer is present within a predetermined acceptable amount, concentration or range.

42. The assembly according to claim 23, further comprising one or more second sensors configured to monitor one or more environmental, physical and/or temporal conditions inside the container.

43. The assembly according to claim 42, wherein said one or more second sensors are situated so as to be able to sense inside the container through a window or an aperture in the cap.

44. An assembly for indicating access to contents of a container, the assembly comprising:
a cap configured to close the container when mounted thereon;
a signal configured to provide an indication to a user of recommended access to the container;
a vibration, shock or motion sensor configured to sense if and how much the container has been shaken, and
wherein the processor is configured to determine, based upon data from the vibration, shock or motion sensor, if the container has been shaken and if the amount that the container has been shaken or the intensity with which the container has been shaken exceeds a predetermined amount, and configured to provide an indication to a user of recommended access to the container upon said determination.

45. The assembly according to claim 44, wherein the indication comprises a light to indicate a recommended access to the container, wherein the light illuminates upon fulfillment of one or more predetermined environmental, physical and/or temporal conditions.

46. The assembly according to claim 44, wherein the indication comprises a light to indicate a non-recommended access to the container, wherein the light illuminates until fulfillment of one or more predetermined environmental, physical and/or temporal conditions.

47. The assembly according to claim 44, wherein the indication comprises a first graphic representation to provide an indication to a user of non-recommended access to the container and/or a second graphic representation to provide an indication to a user of recommended access to the container.

48. The assembly according to claim 44, further comprising an electromechanical locking unit configured to selectively lock the cap onto the container and to unlock the cap from the container to allow access to the container.

49. The assembly according to claim 44, wherein the processor is further configured to unlock the electromechanical locking unit to allow the cap to be detached from the container upon said determination.

50. An assembly for indicating access to contents of a container, the assembly comprising:
a cap configured to close the container when mounted thereon;
a receiver configured to receive a command from a remote device; and
a processor configured to process the command from the remote device and configured to provide an indication to a user of recommended access to the container upon a content of the command.

51. The assembly according to claim 50, wherein the content of the command is dependent upon acceptance of terms of use or approval of a Blockchain agreement concerning the contents of the container.

52. The assembly according to claim 51, wherein the indication comprises a first light to indicate a recommended access to the container, wherein the first light illuminates upon fulfillment of one or more predetermined environmental, physical and/or temporal conditions, or a second light to indicate a non-recommended access to the container, wherein the second light illuminates until fulfillment of one or more predetermined environmental, physical and/or temporal conditions, or both.
